(19) United States
(12) Patent Application Publication
(10) Pub. No.: US 2010/0275807 A1
(43) Pub. Date: Nov. 4, 2010

(54) PHOTOLUMINESCENT NANOCRYSTAL BASED TAGGANTS

(76) Inventors: Daniel P. Landry, Clifton Park, NY (US); Luis A. Sanchez, Albany, NY (US); James C.M. Hayes, Homer, NY (US); Eva M. Sackal, Altamont, NY (US)

Correspondence Address: HOFFMAN WARNICK LLC, 75 STATE STREET, 14TH FLOOR, ALBANY, NY, 12207, US

(21) Appl. No.: 12/031,798

(22) Filed: Feb. 15, 2008

Related U.S. Application Data
(60) Provisional application No. 60/901,704, filed on Feb. 16, 2007.

(51) Int. Cl. F42B 12/40; C09D 5/22; B41M 5/165

(52) U.S. Cl. 102/513; 106/31.01; 106/311

(57) ABSTRACT

A taggant for marking a target through the use of a carrier or a projectile loaded on a firing device and methods for fabricating the same are disclosed. The taggant including photoluminescent semiconductor nanocrystal(s) materials incorporated in a carrier or projectile. The photoluminescent semiconductor nanocrystal(s) materials may be encapsulated in a medium for facilitating marking of the target.

### RELATED APPLICATION

The present application claims the benefit of co-pending provisional application No. 60/901,704, filed on Feb. 16, 2007, which is hereby incorporated herein.

### BACKGROUND OF THE INVENTION

1. Field of the Invention

Projectile markers/taggants are commonly used in military training or in sporting events or recreational games in wooded areas like that of paintball games including woods ball, speedball, stock class, re-ball or T-ball to name a few. The feasibility of marking a target from a distance provided by the use of projectile markers/taggants is also adapted in the forestry industry as well in cattle marking.

Typically, such projectile markers/taggants include a carrier/projectile, incorporating some paint or ink that is loaded onto a firing device or propellant, commonly known as paintball markers, and a paintball gun for propelling the carrier/projectile towards a target. Compressed air/gas is commonly used in propellants for propelling the carrier/projectile towards a target. The carriers/projectiles usually come in a form of gelatin spherical capsules containing primarily polyethylene glycol, other non-toxic and water-soluble substances, and dye.

2. Background Art

Various kinds of compositions of marker/taggant in carriers/projectiles usually include inks, paints, colorants, dyes or pigments in emulsifying agents or liquid solvents. Such liquid solvents may further include dispersing agents, thickeners, and even foaming agents. Some markers/taggants require separate compositions of matter to interact before providing a desired marker/taggant. For example, a capsule may include two separate compartments for holding different chemicals that mix and interact on impact to produce a luminescent mark on a target.

However, the current state of the art does not provide a single composition of matter as a taggant that produces photoluminescence without requiring separate chemicals to react or interact. Also, most markers/taggants currently known are carried in a chamber or cavity of a carrier/projectile. There is no known taggant formulation that does not require a carrier/projectile with a chamber or cavity therein.

In view of the foregoing, a need exists to overcome one or more of the deficiencies in the related art.

### BRIEF SUMMARY OF THE INVENTION

The present disclosure provides a formulation for a taggant for marking a target through the use of a carrier or a projectile. The formulation includes a medium incorporating at least one population of semiconductor nanocrystals and/or at least one population of semiconductor nanocrystal complexes. The medium is a fluid, which may include a gas or liquid. The liquid may be aqueous or non-aqueous liquid. Each of the at least one population of semiconductor nanocrystals and/or semiconductor nanocrystal complexes exhibit photoluminescence, emitting light with a spectral signature unique to the nanocrystal, nanocrystal complex populations or a combination thereof, when illuminated with a short wavelength light source.

In a first aspect of the disclosure, a taggant for marking a surface comprises: a medium, wherein the medium is a fluid selected from a group consisting of: a gas, a liquid and a combination thereof; and a first population of semiconductor nanocrystal(s) materials selected from a group consisting of: nanocrystal cores, nanocrystal complexes and a combination thereof, wherein the semiconductor nanocrystal(s) materials emit a photoluminescent light on exposure to a light source.

A second aspect of the disclosure provides a method of preparing a medium for a taggant for marking a surface, the method comprising: introducing a first component, the first component having a first percentage by weight, introducing a second component to form a mixture with the first component, the second component having a second percentage by weight, wherein the first percentage by weight is greater than the second percentage by weight.

A third aspect of the disclosure provides a method of tagging a target surface, the method comprising: providing a projectile; incorporating a taggant as part of the projectile; and loading the projectile onto a firing device, wherein the incorporating includes one selected from a group consisting of: filling a chamber of the projectile with the taggant and coating the projectile with the taggant, wherein the taggant includes: a medium, wherein the medium is a fluid selected from a group consisting of: a gas, a liquid and a combination thereof; and a population of semiconductor nanocrystal(s) materials selected from a group consisting of: nanocrystal cores, nanocrystal complexes and a combination thereof, wherein the semiconductor nanocrystal(s) materials emit a photoluminescent light on exposure to a light source.

A fourth aspect of the disclosure provides a taggant for marking a surface comprising: a first population of semiconductor nanocrystal(s) materials selected from a group consisting of: nanocrystal cores, nanocrystal complexes and a combination thereof, wherein the semiconductor nanocrystal(s) materials emit a photoluminescent light on exposure to a light source.

The illustrative aspects of the present invention are designed to solve one or more of the problems herein described and/or one or more other problems not discussed.

### DETAILED DESCRIPTION OF THE INVENTION

According to an embodiment of the present disclosure, a system for depositing or marking a target with a photoluminescence taggant is disclosed. The taggant is incorporated as part of a carrier/projectile, which when fired from a firing device, impacts a target surface and releases the taggant to mark the target surface. After making contact at a location or target the projectile deposits said taggant onto said target or location forming an identifying mark that can be observed by illuminating the mark with an appropriate short wavelength light source and visualized with the appropriate equipment. Examples of visualization equipment include, but are not limited to: the unaided human eye, the human eye augmented with night vision goggles, visible and/or infrared camera systems, and spectrometers.

The projectile may be lethal or non-lethal and may include, for example, but is not limited to a capsule, a bullet and a paintball. The taggant may include a medium combined with one or more populations of semiconductor nanocrystals, one or more populations of semiconductor nanocrystal complexes or an aggregate/combination thereof, hereinafter referred to as semiconductor nanocrystal(s) materials. The medium may be a fluid, in which the population of semiconductor nanocrystals and/or complexes may be dispersed to form a suspension. The fluid medium may include water-based formulations and non-water-based formulations. The non-water-based formulation may include a polymer in which semiconductor nanocrystal(s) materials may be encapsulated. The use of a polymer as medium may present an inert environment as a vehicle for the semiconductor nanocrystal(s) materials. Alternatively, the population of semiconductor nanocrystal(s) materials may be provided in powder or granular form for dispersal on impact of the carrier/projectile.

The taggant may be incorporated as part of the projectile by: coating the exterior surface of the projectile with the taggant; or, where the projectile includes a chamber or a cavity, filling the projectile therein with the taggant. In the case where the taggant is incorporated in a chamber of the projectile, the chamber opens/ruptures on impact to release/disperse the taggant onto the target surface. In the case where the taggant is applied as a coating on the projectile, the coating may be achieved by, for example, but not limited to: dipping the projectile into the taggant and spraying or brushing the taggant onto the exterior surface of the projectile. After making contact at a location or target the projectile deposits said taggant onto said target or location forming an identifying mark that can be observed by illuminating the mark with an appropriate short wavelength light source and visualized with the appropriate equipment. Examples of visualization equipment include, but are not limited to: the unaided human eye, the human eye augmented with night vision goggles, visible and/or infrared camera systems, and spectrometers.

For incorporating the taggant onto the exterior surface of the projectile, the medium is required to include viscous and adhesive properties and/or surface tension sufficient for the taggant to adhere to the exterior surface of the projectile and subsequently adhere to the target surface on impact of the projectile. The viscosity and surface tension of the medium allows effective spreading and adhesion of the taggant onto the target surface.

The population of the semiconductor nanocrystal(s) materials includes semiconductor nanocrystal cores and/or complexes that may exhibit a peak emission wavelength between approximately 400 nm and approximately 2500 nm when illuminated by a suitable short wavelength light source. Typically, such light sources include those that have a substantial portion of emitted light of a wavelength shorter than the peak emission wavelength emitted by the semiconductor nanocrystal(s) materials. The light source may include for example, but is not limited to xenon, deuterium, mercury vapor lamps, excimer lasers, UV, Violet, blue LEDs, solid state lasers and diode lasers. Each of these light sources usually have a wavelength that falls within the range of approximately 250 nm to approximately 1550 nm. Different populations of semiconductor nanocrystal(s) materials, of distinct peak emission wavelength, may be combined in various proportions/ratios such that the intensity of emission at each respective peak emission wavelength of the different populations is either the same or distinct. Accordingly, the specific populations of semiconductor nanocrystal(s) materials of distinct peak emission wavelengths and proportions/ratios may be selected to form a combination that presents a unique identifying spectral code.

Each component of the taggant, namely the medium and the semiconductor nanocrystal(s) materials will be discussed in detail in the following paragraphs.

### Semiconductor Nanocrystals

A semiconductor nanocrystal includes a core, which may include a composition of different semiconductors materials/elements. A semiconductor nanocrystal core (alternatively known as a quantum dot or a semiconductor nano-particle) may include an outer surface and a metal layer formed on the outer surface of the semiconductor nanocrystal core. Such compositions of semiconductor nanocrystal cores may include for example, but are not limited to compositions of semiconductors selected from Group II-VI, Group III-V, Group IV-VI, Group I-III-VI, Group II with alloyed Group I-III-VI or any combination thereof. Examples of semiconductor nanocrystal cores having compositions of Group II-VI elements may include, but are not limited to: zinc sulphide (ZnS), zinc selenium (ZnSe), zinc tellurium (ZnTe), cadmium sulphide (CdS), cadmium selenium (CdSe), cadmium tellurium (CdTe), mercury sulphide (HgS), mercury selenium (HgSe) and mercury tellurium (HgTe). Examples of semiconductor nanocrystal cores having compositions of Group III-V elements may include, but are not limited to: aluminum nitride (AlN), aluminum phosphate (AlP), aluminum arsenic (AlAs), aluminum antimony (AlSb), gallium nitride (GaN), gallium phosphate (GaP), gallium arsenic (GaAs), gallium antimony (GaSb), indium nitride (InN), indium phosphate (InP), indium gallium phosphate (InGaP), indium arsenic (InAs) and indium antimony (InSb). Examples of semiconductor nanocrystal cores having compositions of Group IV-VI elements may include, but are not limited to: lead sulphide (PbS), lead selenium (PbSe) and lead tellurium (PbTe). Examples of semiconductor nanocrystal cores having compositions of Group II and Group I-III-VI metal alloys or other elements may include, but are not limited to: copper indium gallium sulphide (CuInGaS₂), copper indium gallium selenium (CuInGaSe₂), zinc copper indium gallium sulphide (ZnCuInGaS₂), zinc copper indium gallium selenium (ZnCuInGaSe₂), sliver indium gallium sulphide (AgInGaS₂) and sliver indium gallium selenium (AgInGaSe₂). The core of such semiconductor nanocrystals may be, but are not limited to: spherical, oblate, obliquely spheroidal or rod-like shapes.

### Semiconductor Nanocrystal Complexes

Semiconductor nanocrystals may further include one or more shells of different semiconductors grown around the outer surface of the semiconductor nanocrystal core to form semiconductor nanocrystal(s) complexes. Shells may comprise various semiconductor materials/elements for example, but not limited to: zinc sulphide (ZnS), zinc selenium (ZnSe), zinc tellurium (ZnTe), cadmium sulphide (CdS), cadmium selenium (CdSe), cadmium tellurium (CdTe), mercury sulphide (HgS), mercury selenium (HgSe), mercury tellurium (HgTe), indium nitride (InN), indium phosphate (InP), indium arsenic (InAs), indium antimony (InSb), gallium nitride (GaN), gallium phosphate (GaP), gallium arsenic (GaAs), gallium antimony (GaSb), lead sulphide (PbS), lead selenium (PbSe) and lead tellurium (PbTe).

The diameter of each semiconductor nanocrystal core is less than that of the bulk Bohr radius for excitons in the same material in which the nanocrystals are composed. The mean diameter of a semiconductor nanocrystal(s) material (i.e., a semiconductor nanocrystal/complex or an aggregate thereof) may range from approximately 1 nm to approximately 20 nm, where the variance of the diameters between any two semiconductor nanocrystals of different populations is less than approximately 20%, more preferably less than approximately 10%.

Semiconductor nanocrystals and/or complexes may be grown by currently know techniques, for example, pyrolysis of organometallic precursors in a chelating ligand solution or by exchange reaction using the prerequisite salts in a chelating ligand solution. The chelating ligands are typically lyophilic having a moiety with an affinity for the metal layer and another moiety with an affinity for the solvent, which is usually hydrophobic. Typical examples of chelating ligands include but are not limited to: lyophilic surfactant molecules such as Trioctylphosphine Oxide (TOPO), Trioctylphosphine (TOP), and Tributylphosphine (TBP).

Semiconductor nanocrystal complexes may absorb energy at a first wavelength, which falls within at least a portion of the ultraviolet or visible spectrum and emit light at a second wavelength. The second wavelength may be greater than the first wavelength.

### The Medium

Various formulations may be used for the medium depending on the target surface. For example, the medium may include a formulation for ink or paint, which may be aqueous or non-aqueous. The following paragraphs discuss the different formulations in detail.

### Viscosity and Surface Tension

The medium may include a suitable viscosity and a surface tension for effectively spreading of the taggant onto the target surface. For example, when the target surface is of high surface energy (e.g., metals or ceramics), the medium having a high viscosity ranging from approximately 200 cps to approximately 1000 cps, and a low surface tension ranging from approximately 15 dynes/cm to approximately 27 dynes/cm may be used to maximize adhesion and spreading of the taggant onto the (high surface energy) target surface. When the target surface is of a low surface energy (e.g., plastics, material containing fluorocarbons), a medium having a higher viscosity may be used to maximize adhesion and spreading of the taggant onto the (low surface energy) target surface. This is because plastics are composed of non-polar, long chain molecules, which are essentially inert, and hence the surface has little free energy to facilitate adhesion of the medium/taggant. The viscosity and surface tension may be adjusted by using different amounts of organic solvents, surfactants and additives such as the ones listed below.

### Surface Energy

Surface energy is defined as the work required for increasing the surface area of a substance per unit area. Surface energy derives from the unsatisfied bonding potential of molecules at a surface, giving rise to ‘free energy’. This is in contrast to molecules within a material, which have less energy because they are subject to interactions with like molecules in all directions. Molecules at an interface between two adjacent phases tend to interact to reduce this free energy. In the case where the two adjacent phases include a gas and a solid, the free energy per unit is termed the “surface energy”. In the case where the two adjacent phases includes a gas and a liquid, the free energy is termed “surface tension”. “Surface tension” is a state of tension at the surface of the liquid, (i.e., defined as work required to increase the surface area of a liquid). Consequently, control of the surface tension of medium (e.g., inks/paints) is critical to ensure proper spreading and adhesion on surfaces.

### I. Water-Based Formulation

The medium as a water-based formulation (e.g., paint and ink compositions) includes an aqueous liquid vehicle with water and a water-soluble vehicle in sufficient amounts to achieve a desired viscosity and surface tension. Water content in such formulations may include, for example, but is not limited to a range from approximately 40% to approximately 90% by weight to achieve a desired viscosity and surface tension.

The semiconductor nanocrystal(s) materials present a color according to the absorption spectrum according to the unique combination of the semiconductor nanocrystal core compositions and shells. The color is unaffected by any medium used in combination with the semiconductor nanocrystal(s) materials. However, the color of the semiconductor nanocrystal(s) materials may shift slightly when combined with different solvents.

Water Soluble Medium

The water soluble vehicle comprises one or more organic solvents, among other optionally suitable constituents. The semiconductor nanocrystal(s) materials may be diluted with a number of solvents including, but not limited to, water, ketones, acetates, glycols, glycol ethers, alcohols, and combinations thereof. Preferably, the semiconductor nanocrystal(s) materials are diluted with solvents such as glycerol, triethylene, glycol mono butyl ether, diethylene glycol, dipropylene glycol, methyl ethyl ketone, 2-pyrollidinone, polyvinylpyrollidinone, polyalcohols, or any other suitable ink or paint diluents. The final percentage composition by weight of the semiconductor nanocrystal(s) materials in the formulation may vary. Typically, the percentage composition may range from approximately 0.1% to approximately 10% by weight of the formulation, and preferably from approximately 1.0% to approximately 7% by weight, and more preferably approximately 1.0% to approximately 5% by weight.

Surfactants

The medium composition may include one or more surfactants including those having non-ionic, anionic, cationic, amphoteric, and zwitterionic moieties. The surfactant, if present, usually ranges from approximately 0.001% to approximately 3.0% by weight. Preferably, the surfactant concentration is about 0.1% by weight of the total composition.

Anionic Surfactants

Typical anionic surfactants for use in medium (e.g., ink) formulations include sodium oleyl succinate, ammonium lauryl sulphosuccinate, ammonium lauryl sulphate, sodium dodecylbenzene sulphonate, triethanolamine dodecylbenzene sulphonate, sodium cocoyl isethionate sodium lauryl isethionate and sodium N-lauryl sarcosinate. The most preferred anionic surfactants may include sodium lauryl sulphate, sodium lauryl ether sulphate (n) ethylene oxide (ER®), where n is an integer, ranging from approximately 1 to approximately 3, ammonium lauryl sulphate and ammonium lauryl ether sulphate (n) ER®, where n ranges from approximately 1 to approximately 3. Other examples of suitable anionic surfactants include, but are not limited to: alkyl sulphates, alkyl ether sulphates, alkaryl sulphonates, alkanoyl isethionates, alkyl succinates, alkyl sulphosuccinates, N-alkyl sarcosinates, alkyl phosphates, alkyl ether phosphates, alkyl ether carboxylates, alpha-olefin sulphonates, including sodium, magnesium, ammonium, and mono-, di- and triethanolamine salts thereof.

Cationic Surfactants

Cationic surfactants used in formulations for the medium, include amino and quaternary ammonium hydrophilic moieties, which are positively charged when dissolved in aqueous compositions of the medium. Examples of suitable cationic surfactants may include those corresponding to a general formula:

[NR₁R₂R₃R₄]₊(X)₋

in which
R₁, R₂, R₃ and R₄ are independently selected from:
   (a) an aliphatic group having approximately 1 to approximately 22 carbon atoms, or
   (b) an aromatic, alkoxy, polyoxyalkylene, alkylamido, hydroxylalkyl, aryl, alkylaryl group having up to 22 carbon atoms; and
X is a salt-forming anion including for example, but not limited to: halogens (e.g., chloride or bromide), acetate, citrate, lactate, glycolate, phosphate, nitrate, sulphate, and alkylsulphate radicals. The aliphatic groups can contain, in addition to carbon and hydrogen atoms, ether linkages, and other groups such as amino groups. The longer chain aliphatic groups, e.g., those of about 12 carbons, or higher, can be saturated or unsaturated.

Typical monoalkyl quaternary ammonium compounds of use in the medium formulations include:

(i) lauryl trimethyl ammonium chloride (available commercially as Arquad® C35 ex-Akzo, Arquad® is a registered trademark of Akzo Nobel Polymer Chemicals, in the US and/or affiliated companies in other countries), cocodimethyl benzyl ammonium chloride (available commercially as Arquad® DMCB-80 ex-Akzo);

(ii) compounds of general formula:

[NR₁R₂((CH₂CH₂O)ₓH)((CH₂CH₂O)_{y}H)]₊X₋,

in which
x+y is an integer ranging from approximately 2 to approximately 20;
R₁ is
   (a) a hydrocarbyl chain with 8 to 14 carbon atoms, preferably 12 to 14 carbon atoms, more preferably 12 carbon atoms, or
   (b) a functionalized carbon chain with 8 to 14 carbon atoms, preferably 12 to 14 carbon atoms, more preferably 12 carbon atoms containing ether, ester, amido or amino moieties present as substituents or as linkages in the radical chain;
R₂ is a C₁ to O₃ alkyl group or benzyl group, preferably methyl; and
X is a salt forming anion including for example, but not limited to: halogen (e.g., chloride or bromide), acetate, citrate, lactate, glycolate, phosphate, nitrate, sulphate, methosulphate and alkylsulphate radicals.

Suitable examples of monoalkyl quaternary ammonium compounds may include, for example, but are not limited to polyethylene glycol(PEG)-n-lauryl ammonium chlorides (where n is an integer corresponding to the number of carbon atoms in the PEG chain, i.e., the PEG length). Examples of such PEG-n-lauryl ammonium compounds may include, but are not limited to: PEG-2 cocomonium chloride (available commercially as Ethoquad® C12 ex-Akzo Nobel, Ethoquad® is a registered trademark of Akzo Nobel Surface Chemistry LLC in the United States and/or affiliated companies in other countries); PEG-2 cocobenzyl ammonium chloride (available commercially as Ethoquad® CB/12 ex-Akzo Nobel); PEG-5 cocomonium methosulphate (available commercially as Rewoquat® CPEM ex-Rewo, Rewoquat® is a registered trademark of Evonik Inductries AG); PEG-15 cocomonium chloride (available commercially as Ethoquad® C/25 ex-Akzo).

(iii) compounds of general formula:

[NR₁R₂ R₃((CH₂)ₙOH)]₊X₋,

in which
n is an integer from approximately 1 to approximately 4, preferably 2;
R₁ is a hydrocarbyl chain with 8 to 14 carbon atoms, preferably 12 to 14 carbon atoms, more preferably 12 carbon atoms,
R₂ and R₃ are each independently selected from, C₁ to C₃ alkyl groups and are preferably methyl; and
X is a salt forming anion including for example, but not limited to: halogen (e.g., chloride or bromide), acetate, citrate, lactate, glycolate, phosphate, nitrate, sulphate and alkylsulphate radicals. Suitable examples include, but are not limited to lauryl dimethylhydroxyethyl ammonium chloride (available commercially as Prapagen HY ex-Clariant).

Non-Ionic Surfactants

The formulations of the medium may also include non-ionic surfactants. Such non-ionic surfactants may include, for example, but are not limited to: primary and secondary alcohol ethoxylates, preferably, aliphatic alcohols with 8 to 20 carbons atoms (i.e., C₈ to C₂₀ aliphatic alcohols) in the carbon chain ethoxylated with an average of from approximately 1 mole to approximately 20moles ethylene oxide per mole of alcohol, and more preferably the C₁₀ to C₁₅ primary and secondary aliphatic alcohols ethoxylated with an average of from approximately 1 mole to approximately 10 moles of ethylene oxide per mole of alcohol. Non-ethoxylated non-ionic surfactants include, for example, but are not limited to alkylpolyglycosides glycerol monoethers and polyhydroxyamides (e.g., glucamide).

Amphoteric and Zwitterionic Surfactants

Examples of amphoteric and zwitterionic surfactants include, but are not limited to: alkyl amine oxides, alkyl betaines, alkyl amidopropyl betaines, alkyl sulphobetaines (sultaines), alkyl glycinates, alkyl carboxylglycinates, alkyl amphopropionates, alkyl amphoglycinates, alkyl amidopropyl hydroxysultaines, acyl taurates and acyl glutamates, where the alkyl and acyl groups include at least approximately 8 to approximately 19 carbon atoms (i.e., C₈-C₁₉ alkyl and acyl groups). Typical amphoteric and zwitterionic surfactants for use in an ink medium formulation include, for example, but are not limited to: lauryl amine oxide, cocodimethyl sulphopropyl betaine and preferably lauryl betaine, cocamidopropyl betaine and sodium cocamphopropionate.

Mixtures of any of the foregoing surfactants may be suitable for water-based ink, paint, and other marking fluid formulations.

Glycol Ethers as Surfactant

Glycol ethers (GE), for example, triethylene glycol mono butyl ether (BTG), may be included as a surfactant to improve polymer solvation by internal hydrogen bonding and improved penetration into the material of the target surface. Other suitable glycols include, but are not limited to: triethylene glycol n-butyl ether (BTG), tripropylene glycol methyl ether (TMP), diethylene glycol methyl ether (DM) and dipropylene glycol methyl ether (DMP). Theses could be used to improve viscosity for a preferred taggant.

Amines

A medium with a water-based formulation may include other constituents for example, amines, for setting a desired pH there in to improve polymer dispersion stability so as to prevent aggregation of the semiconductor nanocrystal(s) materials, or to improve solubility in water, glycol, ether mixtures and to maintain constant viscosity over long periods of rest or when subject to thermal stress. Suitable amines may include, but are not limited to triethanol amine, ethanol amine, diethanolamine, trisopropanolamine, butyldiethanolamine, N,N-dimethylethanolamine, N,N-diethylethanolamine, and N,N-dipropylethanolamine.

### II. Non-Water-Based Formulations

When the liquid medium includes an organic solvent free from water, for non-water-based formulations, (i.e., water content is less than 1% by weight) the solvent may have a boiling point ranging from approximately 30° C. to approximately 300° C., preferably from approximately 40° C. to approximately 150° C., more preferably from approximately 50° C. to approximately 125° C. The organic solvent may be water-immiscible, water-miscible or a mixture thereof. Preferred water-miscible organic solvents are any of the hereinbefore described water-miscible organic solvents and mixtures thereof. Preferred water-immiscible solvents may include, for example, but are not limited to: aliphatic hydrocarbons; esters, preferably ethyl acetate; chlorinated hydrocarbons, preferably dichloromethyl (CH₂Cl₂) and ethers, preferably diethyl ether; and a mixture thereof.

Non-Water-Based Medium

An alternative non-water-based liquid medium for carrying the fluorescent semiconductor nanocrystal(s) materials may include a polymer, for example, but not limited to: Vaseline® (Vaseline® is a registered trademark of Unilever in the United States and/or other countries) or petroleum jelly. Petrolatum is a raw material for forming Vaseline® or petroleum jelly and is a flammable semi-solid mixture of hydrocarbons having a melting point usually ranging from approximately a little below 100° F. (˜37° C.) to a few degrees above. Petrolatum is usually colorless or of a pale yellow color when it is not highly distilled, translucent and devoid of taste and smell when pure. It does not oxidize on exposure to air and is not readily acted on by chemical agents. It is insoluble in water but soluble in chloroform, benzene, carbon disulphide and oil turpentine.

Water-Immiscible Organic Solvents

Where the liquid medium is a composition including a water-immiscible organic solvent for enhancing solubility of semiconductor nanocrystal(s) materials in the liquid medium, a polar water immiscible solvent is preferred. A polar solvent may include, for example, but is not limited to: toluene, chloroform, dichloromethane, octadecane and C₁ to C₄ alcohols. In view of the foregoing, it is preferred that where the liquid medium is an organic solvent free from water, it comprises a ketone (e.g., methyl ethyl ketone) and/or an alcohol (e.g., a C₁ to C₄ alkanol like ethanol or propanol).

The organic solvent free from water may be a single organic solvent or a mixture of two or more organic solvents. It is preferred that when the medium is an organic solvent free from water, it is a mixture including approximately 2 to approximately 5 organic solvents. This provides the medium good control over the drying characteristics and storage stability of the taggant. Liquid media comprising an organic solvent free from water are particularly useful where fast drying is required and particularly when marking onto hydrophobic and non-absorbent substrates, which may include, for example, but is not limited to: plastics, metal and glass.

Additives in Water-Based and/or Non-Water-Based Formulations

Unsaturated Hydrocarbons

A class of additives for incorporating into non-water-based mediums usually includes unsaturated branched (olefins) or straight chain hydrocarbons having a high boiling point in the range of approximately 100° C. to approximately 500° C. Generally, these compounds include C₄ to C₂₈ hydrocarbons and preferably C₈ to C₂₂ hydrocarbons, such as, for example, C₁₄ to C₁₈ alpha-olefins, mesityl oxides, tetradecene, octocosene, docosene, octodecene, etc., or mixtures thereof.

Ethers

Another class of additives that are beneficial in the practice of the invention is high boiling point ethers. The boiling points of these ethers may range from approximately 100° C. to approximately 500° C. This class of additives does not evaporate easily, which contributes to keeping the marked surface wet and sticky. Ethers are also used in water-based formulations for this property. However, if fast drying is desired, ethers with low boiling temperature, for example, but not limited to naphthalene, acetone, methyl ethyl ketone, or low molecular weight alcohols may be used. Typical members of the high boiling point ethers are glycol ethers, for example, but not limited to CELLOSOLVE™ and CARBITOL™, both of which are trademarks of Union Carbide Corporation in the United States and/or other countries. CELLOSOLVE™ includes ethers, for example, but not limited to: 4-methoxy butanol, 2-ethoxy ethanol, 2-propoxy ethanol and 2-butoxy ethanol. CARBITOL™ includes ethers, for example, but not limited to: diethylene glycol ethyl ether and diethylene glycol butyl ether. Glycol ethers with C₄ to C₆ carbons atoms such as diethylene glycol are preferably used as additive

Ether Esters

Yet another class of additives added to either the non-water-based, water-based formulations or both may include ether esters with boiling points ranging from approximately 100° C. to approximately 500° C. Such ether esters may be available commercially under the trademark of CELLOSOLVE™ and CARBITOL™. Typically, ether esters available under the trademark of CELLOSOLVE™ are acetates, for example, but not limited to: methoxy ethyl acetate and butoxy ethyl acetate. Ether esters available under the trademark of CARBITOL™ include, for example, but are not limited to: methoxy diethylene glycol acetate.

Esters

A further class of additives includes esters of boiling points in the range of approximately 100° C. to approximately 500° C. Such esters include C₁ to C₄ alkyl esters, C₄ to C₂₂ aliphatic carboxylic acids, for example, but not limited to: methyl, ethyl, octyl, nonyl, decyl, lauryl, myristyl, palmityl, stearyl esters and any combination thereof. Another example of esters suitable for use as additives in the formulation of the medium may include alkyl ester acids. Examples of alkyl esters acids include, but are not limited to: methyl esters of C₈ to C₁₈ fatty acids, amongst which esters acids of C₈ to C₁₀ and C₁₀ to C₁₈ demonstrate particular usefulness in improving solubility among the different chemical components of the formulation. Other useful esters may be prepared by reacting C₆ to C₂₀ aliphatic acids with C₆ to C₂₈ aliphatic alcohols described in the preceding paragraphs, all of which may be alkoxylated, if desired.

Polymeric Binders

Both water-based and non-water-based formulation may also include a water redispersible latex polymeric binder that is generally non-cross-linking and assists in the dispersion of the semiconductor nanocrystal(s) materials (i.e., it does not contain polymerized N-methyl aniline (NMA) units which cross link to the extent that the polymer becomes relatively non-redispersable). Addition of external cross-linkers is also not desirable. These lattices can either be surfactant protected or stabilized with a protective colloid like polyvinyl alcohol (PVOH) or hydroxyethylcellulose (HEC). Water redispersible latex polymer with PVOH contributes as a stabilizing component in the preparation by aqueous emulsion polymerization. PVOH stabilized vinyl acetate and vinyl acetate based polymers, e.g., acetate-ethylene (VAE) polymer emulsions are preferred due to their ease of water dispersibility. Other PVOH or surfactant-protected polymers include, for example, but are not limited to: acrylic polymers, acrylic copolymers, and styrene butadiene copolymers.

The water redispersible binder can also be a blend of latex as described above with PVOH. These latex/PVOH blends can also contain additives such as poly(acrylic acid), starch, and various humectants or additives with hydroxyl or carboxyl functionality. The PVOH portion of the formulation may include a degree of hydrolyzation ranging from approximately 70% to approximately 100%. Copolymers of PVOH, such as sulfonated material, polyvinyl alcohol, polyvinyl amine or blends of PVOH of different molecular weights and/or degree of hydrolyzation can also be used in the latex blends. Furthermore, the binder can be a member of a family of ion-sensitive water dispersible polymers disclosed in U.S. Pat. No. 6,815,502 and U.S. Pat. No. 6,5999,848, incorporated herein by reference. Examples of commercial binders include, for example, but are not limited to: Vinac® 911 and Vinac® 912 (Vinac® is a trademark of Air. Products, Inc. in the United States and/or other countries) vinyl acetate-poly(vinyl alcohol) polymer emulsions and similar Vinac® products.

Water redispersible latex polymeric binders that can be used include, but are not limited to, vinyl acetate based polymers, e.g., either vinyl acetate homopolymers of VAE polymers stabilized with PVOH and having a glass transition temperature (Tg) of approximately −45° C. to approximately 50° C. There can also be low levels of other monomers polymerized into the VAE polymer backbone. These monomers can include (meth)acrylic acid, crotonic acid, alkyl(meth)acrylates where the alkyl group is C₁ to C₁₂, linear or branched, di- or mono-alkyl maleates where the alkyl group is C₁ to C₁₂, linear or branched, (meth)acrylamide, di-, or mono-alkyl substituted (meth)acrylamides where the alkyl group is C₁ to C₁₂, linear or branched, vinyl esters of alkanoic acids where the alkyl group is C₁ to C₁₂, linear or branched, propylene, vinyl chloride, and vinyl ethylene carbonate.

The PVOH employed as a component of the blend may include a degree of hydrolyzation from approximately 75% by mole to approximately 96% by mole; preferably, approximately 87% by mole to approximately 89% by mole. It can also have a degree of hydrolyzation of greater than 96% by mole. Preferably, PVOH having a high molecular weight and a degree of polymerization (Dpn) ranging from approximately 600 to approximately 2500 or greater is used. This property does not preclude the dispersions from being appropriate binders but may be less desirable in some applications or embodiments. PVOH products are available commercially under the trade name Celvol® (a registered trademark of Celeanese Chemical Company in the United States and/or other countries)

The term poly(acrylic acid) is intended to refer to a polymer having a major portion of poly(acrylic acid). A polymer of poly(acrylic acid) usually includes, for example, at least 50% poly(acrylic acid) formed from the hydrolysis of poly(acrylamide), which consequently leads to the presence of acrylamide residue in the polymer. The polymer may be of any molecular weight, but a preferred average molecular weight range for the poly(acrylic acid) is approximately 100,000 Daltons to approximately 500,000 Daltons. Examples of commercially suitable poly(acrylic acid) include Acumer™ 1540 and Acumer™ 510 (Acumer™ is a trademark of Rohm & Haas Company in the United States and/or other countries), Cyanamer® A15, Cyanamer® A-100L, Cyanamer® P-21, Cyanamer® A-370 (Cyanamer® is a registered trademark of Cytec Inductries, Inc. in the United States and/or other countries), Alcospherse® 124, Alcospherse® 404, Alcospherse®406, Alcospherse®459, Alcospherse®602A and Alcospherse®747 (Alcospherse® is a registered trademark of Aldrich Chemical Company in the United States and/or other countries).

The formulation of non-water-based fluid medium may also contain additional components conventionally used in the manufacture of inks, paints and marking fluids. For example, viscosity modifiers, surface tension modifiers, rheology modifiers, corrosion inhibitors, biocides, additional non-fluorescent colorants and ionic or non-ionic surfactants may be included as additional components.

The medium incorporating the afore-described semiconductors nanocrystal(s) materials may be prepared by any currently known of later developed method suitable for producing such formulations (e.g., inks and paints). For example, the medium may be prepared by adding each component, according to percentage by weight, starting with the component having the highest percentage component by weight from stock solutions. Each component may be subsequently added sequentially according to the respective percentage by weight from the highest to the lowest until all of the components are added to a mixing container. In the case of a water-based formulation, each component may be added to water. The order of addition of the different components in the medium formulation does not affect their performance during imprinting a target surface on impact.

The following examples illustrate preparation and assembly of different components in an embodiment of a formulation of a taggant according to the principles of the foregoing paragraphs.

### Example 1

### Preparation of Polyvinyl Acetate Solution in Water: Solution A.

0.9 g of Vinac® xx210 (Vinac® is a trademark of Air. Products, Inc. in the United States and/or other countries) polyvinyl acetate was mixed in a laboratory mixer with 0.9 g water, 0.1 g lead (II) sulphide (PbS) semiconductor material of 890 nm fluorescent emission, and 0.1 g of toluene. The mixing was carried out with a high speed vortex and sonicated for 4 minutes (at 50% amplitude, in alternating intervals of 10 seconds on, 10 seconds off) with a Branson Sonifier® 450 (Branson Sonifier® is a trademark of Branson Ultrasonics Corp. in the United States and/or other countries).

### Example 2

### Preparation of Polyvinyl Acetate Solution in Glycerol: Solution B.

0.9 g of Vinac® xx 210 polyvinyl acetate was mixed in a laboratory mixer with 0.9 g glycerol, 0.1 g lead (II) sulphide (PbS) semiconductor material of 890 nm fluorescent emission, and 0.1 g of toluene. The mixing was carried out with a high speed vortex and sonicated for 4 minutes (at 50% amplitude, in alternating intervals of 10 seconds on and 10 seconds off) with a Branson Sonifier® 450.

### Example 3

### Preparation of Polyvinyl Alcohol Solution: Solution C.

10 w % of Celvol® 107 (Celvol® is a trademark of Celeanese corporation in the United States and/or other countries) polyvinyl alcohol in water was dissolved at 100° C. until the entire polymer was dissolved. Then 1.8 g of the Celvol 107 solution was mixed with 0.1 g PbS semiconductor of 890 nm fluorescent emission material, and 0.1 g of toluene. Mixing and sonication was carried out as described above.

### Example 4

### Preparation of Lead (II) Sulphide (PbS) Fluorescent Semiconductor Nanocrystal(s) Material Taggant

Several compositions of fluorescent PbS semiconductor nanocrystal(s) materials fluids may be prepared by mixing the various fluid mediums prepared according to the method set out in Examples 1-3 above. For example, three formulations, F1, F2, F3, according to percentage composition (by weight/volume) are set out in Table I (shown below):

TABLE I

| | Percentage | | |
|---|---|---|---|
| | Composition (%) | | |
| | Formulations | | |
| Ingredients | F1 | F2 | F3 |
| PbS semiconductor nanocrystal(s) material in Toluene | — | — | 10 |
| at concentration of 107 mg/mol | | | |
| Vaseline | 50 | 50 | 90 |
| Polymer Solution A (From Example 1) | 50 | — | — |
| Polymer Solution C (From Example 3) | — | 50 | — |

Using a syringe, empty paintball shells, X-Ball Shell sold under the trademark of DXS™/DraXxuS™, (DXS™ and DraXxuS™ are a trademarks of Procaps, LP in the United States and/or other countries) were filled with a taggant selected from one of Solution A (from Example 1), Solution B (from Example 2), Solution C (from Example 3), a combination of Solution B (from Example 2) and Solution C (from Example 3), formulation F1, formulation F2, and formulation F3 from Table I respectively. The filled paintball shells were placed in refrigerators at a temperature ranging from approximately −5° C. to approximately 5° C., preferably approximately 2° C., for about 2 minutes. The filled paintball shells are then removed from the refrigerator and allowed to return to room temperature. The filled paintball shells were loaded into a firing device, a VL Lancer (paintball) Gun sold under the trademark of Viewloader® (Viewloader® is a trademark of JT® Sports LLC in the United States and/or other countries) and fired at a target wood board surface. Verification of fluorescence emission of the impact marking on the target after impact was confirmed with night vision goggles during illumination with a UV light that emits ultraviolet radiation at 375 nm. The goggles collect any light in the immediate area and amplify it by several thousand times using an image intensifier.

In an alternative embodiment, the paintball may be replaced by another projectile for example, but not limited to a bullet or a capsule and may be charged with a taggant during manufacture by filling a chamber in the bullet/capsule or by coating the exterior surface of the paintball, bullet or capsule. The paintball/bullet/capsule may be coated by dipping into the taggant, or alternatively, by spraying, brushing or any other suitable manner of applying the taggant onto the surface of the paintball/bullet/capsule.

The current disclosure provides for projectiles carrying different taggants such that each projectile may be charged with a different taggant. With different taggants being distinct, specific identification may be designated/associated with a particular purpose or user. For example, if there are six projectiles to be fired from a magazine, each projectile may be charged with a taggant of different color or different fluorescent emission. The six projectiles may include a taggant having color or fluorescent emissions of green, near infrared, blue, yellow silver and purple. By employing different color for each projectile, one may readily determine which bullet or shot hit where on the target. If each projectile is fired by a different individual, the color or fluorescent emission associated with each individual facilitates identification of which shot had been fired by which individual.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A taggant for marking a surface comprising:
a medium, wherein the medium is a fluid selected from a group consisting of: a gas, a liquid and a combination thereof; and
a first population of semiconductor nanocrystal(s) materials selected from a group consisting of: nanocrystal cores, nanocrystal complexes and a combination thereof, wherein the semiconductor nanocrystal(s) materials emit a photoluminescent light on exposure to a light source.

2. The taggant of claim 1, wherein the fluid includes a viscosity and a surface tension, wherein each of the viscosity and the surface tension is dependent on a proportion of components selected from a group consisting of: solvents, surfactants, additives and combinations thereof.

3. The taggant of claim 2, wherein the fluid is selected from a group consisting of: water-based formulations, non-water-based formulations and a combination thereof.

4. The taggant of claim 3, wherein, in the case where the fluid is a water-based formulation, the fluid further includes an aqueous liquid vehicle comprising water and a water soluble vehicle, wherein the water content range from between approximately 40% to approximately 90% by weight.

5. The taggant of claim 4, wherein the water soluble vehicle includes a solvent selected from a group consisting of: glycerol, triethylene, glycol mono butyl ether, diethylene glycol, dipropylene glycol, methyl ethyl ketone, 2-pyrollidinone, polyvinylpyrollidinone, polyalcohols and a combination thereof.

6. The taggant of claim 2, wherein the fluid includes a viscosity ranging from approximately 200 cps to approximately 1000 cps, and a surface tension ranging from approximately 15 dynes/cm to approximately 27 dynes/cm.

7. The taggant of claim 2, wherein the surfactant includes a moiety selected from a group consisting of: non-ionic, anionic, cationic, amphoteric, zwitterionic and a combination thereof.

8. The taggant of claim 2, wherein the fluid further includes an amine selected from a group consisting of: triethanol amine, ethanol amine, diethanol amine, trisopropanolamine, butyldiethanolamine, N,N-dimethylethanolamine, N,N-diethylethanolamine, and N,N-dipropylethanolamine.

9. The taggant of claim 3, wherein, in the case where the fluid is a non-water-based formulation, the fluid further includes one selected from a group consisting of: a polymer and an organic solvent having water content at less than 1% by weight, wherein the organic solvent is selected from a group consisting of: water-immiscible solvents, water-miscible solvents and a combination thereof.

10. The taggant of claim 9, wherein the polymer includes one selected from a group consisting of: petroleum jelly, products of petrolatum and a combination thereof.

11. The taggant of claim 9, wherein the non-water-based formulation of the medium includes approximately 2 to approximately 5 organic solvents.

12. The taggant of claim 9, wherein the water-immiscible solvent includes one selected from a group consisting of: aliphatic hydrocarbons, esters, chlorinated hydrocarbons, ethers and a combination thereof.

13. The taggant of claim 11, wherein water-immiscible solvent includes a polar solvent selected from a group consisting of: toluene, chloroform, dichloromethane, octadecane, C₁-C₄ alcohols and a combination thereof.

14. The taggant of claim 9, wherein the wherein the non-water-based formulation of the medium further includes an additive selected from a group consisting of: unsaturated hydrocarbons, ethers, ether esters, esters, polymeric binders and a combination thereof.

15. The taggant of claim 1, wherein the first population of semiconductor nanocrystal(s) materials exhibit a peak emission wavelength ranging from approximately 400 nm to approximately 2500 nm.

16. The taggant of claim 1, further including a second population of semiconductor nanocrystal(s) materials, wherein the photoluminescent light emitted by the combination of the first population and the second population of semiconductor nanocrystal(s) materials generates a unique spectral code.

17. The taggant of claim 1, wherein the photoluminescent light includes a peak emission at a distinct wavelength.

18. The taggant of claim 1, wherein the nanocrystal cores and nanocrystal complexes include a composition of different semiconductor materials, and wherein the nanocrystal complexes include shells of semiconductor materials.

19. The taggant of claim 17, wherein the nanocrystal cores include a shape selected from a group consisting of: spheres, obliques, oblates and rod-shapes, wherein the nanocrystal cores include a diameter ranging from between approximately 1 nm and approximately 20 nm.

20. The taggant of claim 18, wherein the nanocrystal cores include a semiconductor material selected from a group consisting of Group II-VI, Group III-V, Group IV-VI, Group I-III-VI, Group II with alloyed Group I-III-VI and a combination thereof.

21. The taggant of claim 19, wherein the Group II-VI semiconductor material is selected from a group consisting of: zinc sulphide (ZnS), zinc selenium (ZnSe), zinc tellurium (ZnTe), cadmium sulphide (CdS), cadmium selenium (CdSe), cadmium tellurium (CdTe), mercury sulphide (HgS), mercury selenium (HgSe) and mercury tellurium (HgTe),

22. The taggant of claim 19, wherein the Group III-V semiconductor material is selected from a group consisting of: aluminum nitride (AlN), aluminum phosphate (AlP), aluminum arsenic (AlAs), aluminum antimony (AlSb), gallium nitride (GaN), gallium phosphate (GaP), gallium arsenic (GaAs), gallium antimony (GaSb), indium nitride (InN), indium phosphate (InP), indium gallium phosphate (InGaP), indium arsenic (InAs) and indium antimony (InSb).

23. The taggant of claim 19, wherein the Group IV-VI semiconductor material is selected from a group consisting of: lead sulphide (PbS), lead selenium (PbSe) and lead tellurium (PbTe).

24. The taggant of claim 19, wherein the Group II with Group I-III-VI alloys of semiconductor material is selected from a group consisting of: copper indium gallium sulphide (CuInGaS₂), copper indium gallium selenium (CuInGaSe₂), zinc copper indium gallium sulphide (ZnCuInGaS₂), zinc copper indium gallium selenium (ZnCuInGaSe₂), sliver indium gallium sulphide (AgInGaS₂) and sliver indium gallium selenium (AgInGaSe₂).

25. The taggant of claim 17, wherein the shells of the nanocrystal complexes are selected from a group consisting of: zinc sulphide (ZnS), zinc selenium (ZnSe), zinc tellurium (ZnTe), cadmium sulphide (CdS), cadmium selenium (CdSe), cadmium tellurium (CdTe), mercury sulphide (HgS), mercury selenium (HgSe), mercury tellurium (HgTe), indium nitride (InN), indium phosphate (InP), indium arsenic (InAs), indium antimony (InSb), gallium nitride (GaN), gallium phosphate (GaP), gallium arsenic (GaAs), gallium antimony (GaSb), lead sulphide (PbS), lead selenium (PbSe) and lead tellurium (PbTe).

26. The taggant of claim 17, wherein the semiconductor nanocrystal complexes absorb energy at a first wavelength that falls within at least a portion of ultraviolet or visible spectrum and emit light at a second wavelength.

27. The taggant of claim 1, wherein the light source produces light having a substantial portion at a wavelength shorter than the peak emission wavelength emitted by the semiconductor nanocrystal(s) materials,

28. The taggant of claim 1, wherein the energy source includes xenon lamps, deuterium lamps, mercury vapor lamps, excimer lasers, light emitting diodes (LEDs), Ultra Violet LEDs, Violet LEDs, Blue LEDs, solid state lasers and diode lasers, gas lasers, doubled frequency titanium (Ti): Sapphire lasers, tripled frequency titanium (Ti): Sapphire lasers, doubled frequency neodymium (Nd): yttrium aluminum garnet (YAG) lasers wherein the wavelength has a wavelength that falling within a range of approximately 250 nm to approximately 1550 nm.

29. A method of preparing a medium for a taggant for marking a surface, the method comprising:
introducing a component, the component having a first percentage by weight,
introducing a subsequent component to form a mixture with the component, the subsequent component having a second percentage by weight, wherein the first percentage by weight is greater than the second percentage by weight.

30. The method of claim 29, further includes repeating the introducing a subsequent component until each subsequent component is incorporated in the mixture.

31. A method of tagging a target surface, the method comprising:
providing a projectile;
incorporating a taggant as part of the projectile; and
loading the projectile onto a firing device,
wherein the incorporating includes one selected from a group consisting of: filling a chamber of the projectile with the taggant and coating the projectile with the taggant,
wherein the taggant includes:
a medium, wherein the medium is a fluid selected from a group consisting of: a gas, a liquid and a combination thereof; and
a population of semiconductor nanocrystal(s) materials selected from a group consisting of: nanocrystal cores, nanocrystal complexes and a combination thereof, wherein the semiconductor nanocrystal(s) materials emit a photoluminescent light on exposure to a light source.

32. A taggant for marking a surface comprising:
a first population of semiconductor nanocrystal(s) materials selected from a group consisting of: nanocrystal cores, nanocrystal complexes and a combination thereof, wherein the semiconductor nanocrystal(s) materials emit a photoluminescent light on exposure to a light source.

33. The taggant of claim 32, wherein the first population of semiconductor nanocrystal(s) materials exhibit a peak emission wavelength ranging from approximately 400 nm to approximately 2500 nm.

34. The taggant of claim 32, further including a second population of semiconductor nanocrystal(s) materials, wherein the photoluminescent light emitted by the combination of the first population and the second population of semiconductor nanocrystal(s) materials generates a unique spectral code.

35. The taggant of claim 32, wherein the photoluminescent light includes a peak emission at a distinct wavelength.

36. The taggant of claim 32, wherein the nanocrystal cores and nanocrystal complexes include a composition of different semiconductor materials, and wherein the nanocrystal complexes include shells of semiconductor materials.

37. The taggant of claim 35, wherein the nanocrystal cores include a shape selected from a group consisting of: spheres, obliques, oblates and rod-shapes, wherein the nanocrystal cores include a diameter ranging from between approximately 1 nm and approximately 20 nm.

38. The taggant of claim 36, wherein the nanocrystal cores include a semiconductor material selected from a group consisting of Group II-VI, Group III-V, Group IV-VI, Group I-III-VI, Group II with alloyed Group I-III-VI and a combination thereof.

39. The taggant of claim 37, wherein the Group II-VI semiconductor material is selected from a group consisting of: zinc sulphide (ZnS), zinc selenium (ZnSe), zinc tellurium (ZnTe), cadmium sulphide (CdS), cadmium selenium (CdSe), cadmium tellurium (CdTe), mercury sulphide (HgS), mercury selenium (HgSe) and mercury tellurium (HgTe),

40. The taggant of claim 37, wherein the Group III-V semiconductor material is selected from a group consisting of: aluminum nitride (AlN), aluminum phosphate (AlP), aluminum arsenic (AlAs), aluminum antimony (AlSb), gallium nitride (GaN), gallium phosphate (GaP), gallium arsenic (GaAs), gallium antimony (GaSb), indium nitride (InN), indium phosphate (InP), indium gallium phosphate (InGaP), indium arsenic (InAs) and indium antimony (InSb).

41. The taggant of claim 37, wherein the Group IV-VI semiconductor material is selected from a group consisting of: lead sulphide (PbS), lead selenium (PbSe) and lead tellurium (PbTe).

42. The taggant of claim 37, wherein the Group II with Group I-III-VI alloys of semiconductor material is selected from a group consisting of: copper indium gallium sulphide (CuInGaS₂), copper indium gallium selenium (CuInGaSe₂), zinc copper indium gallium sulphide (ZnCuInGaS₂), zinc copper indium gallium selenium (ZnCuInGaSe₂), sliver indium gallium sulphide (AgInGaS₂) and sliver indium gallium selenium (AgInGaSe₂).

43. The taggant of claim 35, wherein the shells of the nanocrystal complexes are selected from a group consisting of: zinc sulphide (ZnS), zinc selenium (ZnSe), zinc tellurium (ZnTe), cadmium sulphide (CdS), cadmium selenium (CdSe), cadmium tellurium (CdTe), mercury sulphide (HgS), mercury selenium (HgSe), mercury tellurium (HgTe), indium nitride (InN), indium phosphate (InP), indium arsenic (InAs), indium antimony (InSb), gallium nitride (GaN), gallium phosphate (GaP), gallium arsenic (GaAs), gallium antimony (GaSb), lead sulphide (PbS), lead selenium (PbSe) and lead tellurium (PbTe).

44. The taggant of claim 35, wherein the semiconductor nanocrystal complexes absorb energy at a first wavelength that falls within at least a portion of ultraviolet or visible spectrum and emit light at a second wavelength.

45. The taggant of claim 32, wherein the light source produces light having a substantial portion at a wavelength shorter than the peak emission wavelength emitted by the semiconductor nanocrystal(s) materials,

46. The taggant of claim 32, wherein the energy source includes xenon lamps, deuterium lamps, mercury vapor lamps, excimer lasers, light emitting diodes (LEDs), Ultra Violet LEDs, Violet LEDs, Blue LEDs, solid state lasers and diode lasers, gas lasers, doubled frequency titanium (Ti): Sapphire lasers, tripled frequency titanium (Ti): Sapphire lasers, doubled frequency neodymium (Nd): yttrium aluminum garnet (YAG) lasers wherein the wavelength has a wavelength that falling within a range of approximately 250 nm to approximately 1550 nm.
